(19) United States
(12) Patent Application Publication
(10) Pub. No.: US 2007/0092359 A1
(43) Pub. Date: Apr. 26, 2007

(54) Access to one or more levels of material storage shelves by an overhead hoist transport vehicle from a single track position

(75) Inventors: Richard J. Pickreign, Harvard, MA (US); Jeffrey T. Tawyer, Danvers, MA (US); Brian Doherty, Weston, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Brooks Automation, Inc.

(21) Appl. No.: 11/580,697

(22) Filed: Oct. 13, 2006

Related U.S. Application Data
(63) Continuation-in-part of application No. 10/682,809, filed on Oct. 9, 2003.
(60) Provisional application No. 60/417,993, filed on Oct. 11, 2002.

(51) Int. Cl. B65G 1/00

(52) U.S. Cl. 414/281

(57) ABSTRACT

An improved automated material handling system that allows an overhead hoist supported by a suspended track to access Work-In-Process (WIP) parts from storage locations beside the track. The automated material handling system includes an overhead hoist transport vehicle for transporting an overhead hoist on a suspended track, and one or more storage bins for storing WIP parts located beside the track. Each storage bin is either a movable shelf or a fixed shelf. To access a WIP part from a selected shelf, the overhead hoist transport vehicle moves along the suspended track to a position at the side of the shelf. Next, the movable shelf moves to a position underneath the overhead hoist. Alternatively, overhead hoist moves to a position above the fixed shelf. The overhead hoist is then operated to pick a desired WIP part directly from the shelf, or to place one or more WIP parts directly to the shelf. Once the WIP part is held by the overhead hoist, the overhead hoist transport vehicle moves the WIP part to a workstation or processing machine on the product manufacturing floor.

### CROSS REFERENCE TO RELATED APPLICATIONS

This continuation-in-part application claims benefit of U.S. patent application Ser. No. 10/682,809 filed Oct. 9, 2003 entitled ACCESS TO ONE OR MORE LEVELS OF MATERIAL STORAGE SHELVES BY AN OVERHEAD HOIST TRANSPORT VEHICLE FROM A SINGLE TRACK POSITION, and U.S. Provisional Patent Application No. 60/417,993 filed Oct. 11, 2002 entitled OFFSET ZERO FOOTPRINT STORAGE (ZFS) USING MOVING SHELVES OR A TRANSLATING HOIST PLATFORM.

### STATEMENT REGARDING FEDERALLY SPONSORED RESEARCH OR DEVELOPMENT

N/A

### BACKGROUND OF THE INVENTION

The present application relates generally to automated material handling systems, and more specifically to an automated material handling system that allows an overhead hoist on a suspended track to access Work-In-Process (WIP) parts stored beside the track.

Automated material handling systems are known that employ WIP storage units and overhead hoists to store WIP parts and to transport them between workstations and/or processing machines in a product manufacturing environment. For example, such an automated material handling system may be employed in the fabrication of Integrated Circuit (IC) chips. A typical process of fabricating IC chips includes various processing steps such as deposition, cleaning, ion implantation, etching, and passivation steps. Each of these steps in the IC chip fabrication process may be performed by a different processing machine such as a chemical vapor deposition chamber, an ion implantation chamber, or an etcher. Further, the WIP parts, in this case, semiconductor wafers, are typically transported between the different workstations and/or processing machines multiple times to perform the various steps required for fabricating the IC chips.

A conventional automated material handling system used in an IC chip fabrication process comprises a plurality of WIP storage units for storing semiconductor wafers, and one or more transport vehicles including respective overhead hoists for moving the wafers between workstations and processing machines on the IC chip manufacturing floor. The semiconductor wafers stored in the WIP storage units are typically loaded into carriers such as Front Opening Unified Pods (FOUPs), each of which may be selectively accessed via an overhead hoist carried by a respective overhead hoist transport vehicle traveling on a suspended track. In a typical system configuration, the FOUPs are stored in WIP storage units located underneath the track. Accordingly, the overhead hoist transport vehicle is typically moved along the suspended track to a position directly above a selected FOUP, and the overhead hoist is lowered toward the FOUP and operated to pick the FOUP from the WIP storage unit or to place a FOUP to the WIP storage unit.

One drawback of the above-described conventional automated material handling system is that the overhead hoist is capable of accessing just a single level of WIP storage underneath the suspended track. This is problematic because providing only one level of WIP storage on the product manufacturing floor can increase costs due to the inefficient use of floor space. In order to access multiple levels of WIP storage beneath the track, the WIP storage unit must be configured to move a selected FOUP from its current position in the storage unit to a position at the level accessible to the overhead hoist. However, requiring the WIP storage unit to move the selected FOUP to the level beneath the track that is accessible to the overhead hoist can significantly lower the throughput of the material handling system. Further, such a WIP storage unit typically has many moving parts such as rollers, bearings, and motors that are subject to failure, which not only increases costs but also diminishes the reliability of the overall system.

Moreover, because overhead hoists included in conventional automated material handling systems access WIP parts from storage units located underneath a suspended track, a minimum amount of space is typically required between the ceiling and floor of the product manufacturing facility to accommodate the track and the overhead hoist transport vehicles. This further limits the amount of space in the manufacturing facility that might otherwise be used for storing WIP parts. In addition, because only one level of WIP storage is accessible to each overhead hoist, multiple overhead hoists must normally queue up at a WIP storage unit to access WIP parts from that storage unit, thereby further lowering system throughput.

It would therefore be desirable to have an automated material handling system that provides enhanced material handling efficiency while overcoming the drawbacks of conventional automated material handling systems.

### BRIEF SUMMARY OF THE INVENTION

In accordance with the present invention, an improved Automated Material Handling System (AMHS) is provided that allows an overhead material transport vehicle supported by a suspended track to access Work-In-Process (WIP) parts from storage locations beside the track. By allowing the overhead material transport vehicle to access WIP parts stored beside the track, the presently disclosed automated material handling system makes more efficient use of space, and provides higher throughput, enhanced reliability, and reduced costs.

In a one embodiment, the automated material handling system includes at least one overhead hoist transport subsystem having an overhead track, at least one translating arm for supporting at least one material unit, and an overhead hoist transport vehicle for carrying the translating arm to a plurality of track locations along the overhead track, and for lowering and raising the translating arm to a plurality of levels, in which each level corresponds to at least one of the track locations. The translating arm includes at least one mechanism for conveying at least one material unit along the length of the arm. The material storage location, which is configured to store at least one material unit, is disposed at a predetermined level on a first side of the track. In one mode of operation, the overhead hoist transport vehicle carries the translating arm along the overhead track to a track location adjacent the material storage location, and either lowers or raises the translating arm for positioning the arm at approximately the predetermined level of the material storage location. The translating arm is configured, at least while being positioned at the approximate level of the material storage location, to move from a first position within the overhead hoist transport vehicle to a second position outside of the vehicle by moving laterally toward the first side of the overhead track, thereby allowing the conveying mechanism to move at least one material unit from the material storage location onto at least a portion of the length of the arm, or to move at least one material unit from the arm to the material storage location.

In the presently disclosed embodiment, the material storage location is a shelf, and the translating arm includes a pair of translating arms. When the pair of translating arms is disposed at the second position outside of the overhead material transport vehicle, the pair of translating arms is positioned adjacent to and on opposing sides of the shelf. In addition, the width of the material unit, e.g., a FOUP, is greater than the width of the shelf, thereby allowing portions of a bottom surface of the FOUP to overhang the opposing sides of the shelf while it is stored on the shelf. The conveying mechanism included in the translating arms is configured to contact the overhanging portions of the FOUP while the arms are positioned adjacent to and on the opposing sides of the shelf. For example, the conveying mechanism may include a plurality of active rollers. Further, the shelf may include a plurality of passive rollers on a surface thereof to facilitate the movement of the FOUP to and from the shelf.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a block diagram of an IC chip manufacturing environment including an automated material handling system according to the present invention;

FIGS. 2a-2b are block diagrams of a first embodiment of offset zero footprint storage employed in the automated material handling system of FIG. 1, in which the offset zero footprint storage comprises a single row of movable shelves;

FIGS. 3a-3b are block diagrams of the first embodiment of offset zero footprint storage of FIG. 2, in which the offset zero footprint storage comprises multiple rows of movable shelves;

FIGS. 4a-4b are block diagrams of a second embodiment of offset zero footprint storage employed in the automated material handling system of FIG. 1, in which the offset zero footprint storage comprises a single row of fixed shelves and an overhead hoist mechanism mounted on a translating stage;

FIG. 5 is a block diagram of the overhead hoist mechanism of FIGS. 4a-4b employed in conjunction with a WIP storage unit;

FIG. 6 is a block diagram of the overhead hoist mechanism of FIGS. 4a-4b employed in conjunction with a WIP part conveying system;

FIG. 7 is a perspective view of an alternative embodiment of the overhead hoist mechanism of FIGS. 4a-4b;

FIG. 8 is a perspective view of the overhead hoist mechanism of FIG. 7 employed in conjunction with an array of fixed shelves;

FIG. 9 is a perspective view of multiple overhead hoist mechanisms like the overhead hoist mechanism of FIG. 7, in which the overhead hoist mechanisms travel on the same track and are employed in conjunction with an array of fixed shelves;

FIG. 10 is a perspective view of multiple overhead hoist mechanisms like the overhead hoist mechanism of FIG. 7, in which the overhead hoist mechanisms travel on respective tracks and are employed in conjunction with back-to-back arrays of fixed shelves;

FIG. 11 is a perspective view of a third embodiment of offset zero footprint storage, in which the overhead hoist mechanism of FIG. 7 is employed in conjunction with multiple rows of fixed shelves;

FIGS. 12a-12b are flow diagrams of illustrative methods of operating the automated material handling system of FIG. 1;

FIG. 13 is a flow diagram of an illustrative method of controlling the automated material handling system of FIG. 1;

FIGS. 14a-14b are perspective views of the translating stage of FIGS. 4a-4b;

FIGS. 15a-15b are perspective views of another alternative embodiment of the overhead hoist mechanism of FIGS. 4a-4b; and

FIGS. 15c-15k are views illustrating various modes of operating the overhead hoist mechanism of FIGS. 15a-15b.

### DETAILED DESCRIPTION OF THE INVENTION

The disclosures of U.S. patent application Ser. No. 10/682,809 filed Oct. 9, 2003 entitled ACCESS TO ONE OR MORE LEVELS OF MATERIAL STORAGE SHELVES BY AN OVERHEAD HOIST TRANSPORT VEHICLE FROM A SINGLE TRACK POSITION, and U.S. Provisional Patent Application No. 60/417,993 filed Oct. 11, 2002 entitled OFFSET ZERO FOOTPRINT STORAGE (ZFS) USING MOVING SHELVES OR A TRANSLATING HOIST PLATFORM, are incorporated herein by reference in their entirety.

An improved automated material handling system is disclosed that allows an overhead hoist mechanism supported by a suspended track to access Work-In-Process (WIP) parts from storage bins located beside the track. The presently disclosed automated material handling system makes more efficient use of space while providing higher throughput, enhanced reliability, and reduced costs.

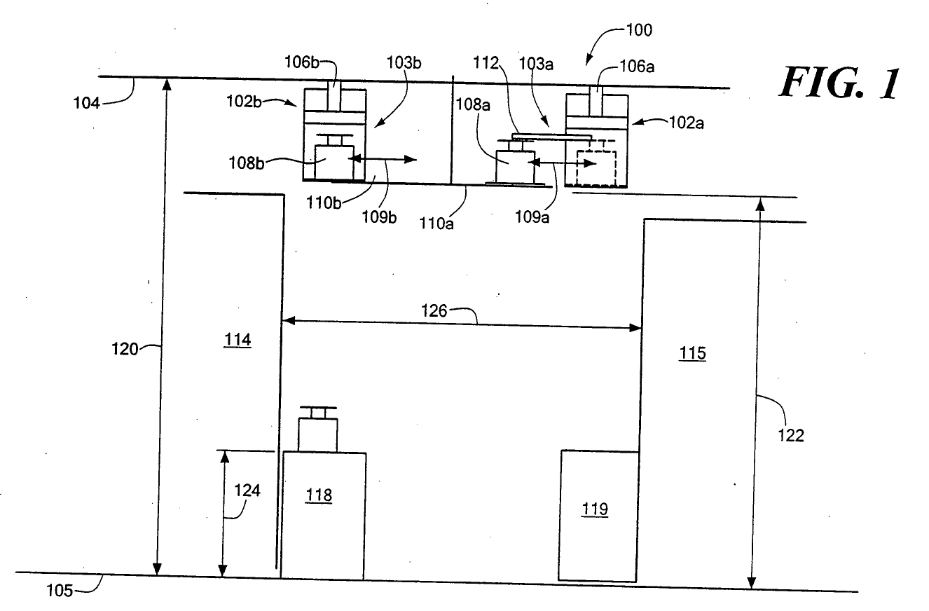

FIG. 1 depicts an illustrative embodiment of a product manufacturing environment 101 including an Automated Material Handling System (AMHS) 100, in accordance with the present invention. In the illustrated embodiment, the AMHS 100 is configured for automatically storing WIP parts and transporting them between various workstations and/or processing machines, e.g., processing machines 114-115 having input/output ports 118-119, respectively, within the product manufacturing environment 101.

It is noted that the AMHS 100 may be employed in a clean environment for manufacturing Integrated Circuit (IC) chips such as a 200 mm or 300 mm FAB plant, or any other suitable product manufacturing environment. As shown in FIG. 1, the IC chip manufacturing environment 101 includes a ceiling 104 and a floor 105, which is typically covered with an electrically nonconductive material and designed to meet specific loading and seismic requirements. Further, the processing machines 114-115 are configured to perform various processing steps for fabricating the IC chips. For example, the ceiling 104 may be located a distance 120 of about 3.5 m above the floor 105, the processing machines 114-115 may be spaced a distance 126 of at least about 1.9 m apart, and a top surface of the input/output ports 118-119 may be a distance 124 of about 0.9 m from the floor 105.

In the illustrated embodiment, the AMHS 100 includes overhead hoist transport vehicles 102a-102b movably coupled to tracks 106a-106b, respectively, both of which are suspended from the ceiling 104. The overhead hoist transport vehicles 102a-102b are configured to move respective overhead hoists along the tracks 106a-106b for accessing carriers such as Front Opening Unified Pods (FOUPs) 108a-108b designed to hold WIP parts, i.e., semiconductor wafers. As shown in FIG. 1, the FOUPs 108a-108b are stored in storage bins such as shelves 110a-110b, respectively. Further, the suspended tracks 106a-106b define predetermined routes passing at the side of the shelves 110a-110b, respectively, thereby allowing the overhead hoist transport vehicles 102a-102b to access the FOUPs 108a-108b directly from the respective shelves 110a-110b. For example, the overhead hoist transport vehicles 102a-102b may be disposed a distance 122 of about 2.6 m above the floor 105.

Specifically, the shelf 110a is a passive or fixed shelf, which may be one of a number of fixed shelves disposed in a row beside and substantially parallel to the suspended track 106a. It should be understood that one or more rows of fixed shelves may be disposed on either side or on both sides of the track 106a. In the illustrated embodiment, to access the FOUP 108a from the fixed shelf 110a, the overhead hoist transport vehicle 102a moves along the suspended track 106a to a position at the side of the shelf 110a. Next, a translating stage 112 included in the overhead hoist transport vehicle 102a moves the overhead hoist laterally from a first position within the overhead hoist transport vehicle 102a to a second position substantially directly above the fixed shelf 110a, as indicated by directional arrows 109a. The overhead hoist is then operated to pick the FOUP 108a directly from the shelf 110a for subsequent transport to a workstation or processing machine on the IC chip manufacturing floor. It is understood that the overhead hoist may alternatively place one or more FOUPs to the shelf 110a. It is also noted that the translating stage 112 may be configured to allow the overhead hoist to pick/place a FOUP from/to either side of the overhead hoist transport vehicle 102a.

In the preferred embodiment, the fixed shelf 110a may be at substantially the same height above the floor 105 as the overhead hoist transport vehicle 102a. In this embodiment, the overhead hoist transport vehicle 102a includes a cowl 103a having an opening formed therethrough to allow the translating stage 112 to move from within the transport vehicle to its position above the fixed shelf 110a. After having picked the FOUP 108a from the shelf 110a, the FOUP 108a passes through the opening in the cowl 103a as the translating stage 112 is moved back to its original position within the overhead hoist transport vehicle 102a.

Whereas the shelf 110a comprises a fixed shelf, the shelf 110b is a movable shelf. Like the fixed shelf 110a, the movable shelf 110b may be one of a number of movable shelves disposed in a row beside and substantially parallel to the suspended track 106b. Further, one or more rows of movable shelves may be disposed on either side or on both sides of the track 106b. In the illustrated embodiment, to access the FOUP 108b on the movable shelf 110b, the overhead hoist transport vehicle 102b moves along the suspended track 106b to a position at the side of the shelf 110b. Next, the shelf 110b moves laterally from a first position beside the track 106b to a second position substantially directly underneath the overhead hoist within the overhead hoist transport vehicle 102b, as indicated by directional arrows 109b. For example, the movable shelf 110b may be provided with a mechanism for moving the shelf 110b along a pneumatically, stepper motor, or servo motor controlled axis between the first position beside the track 106b and the second position under the track and overhead hoist. The overhead hoist is then operated to pick the FOUP 108b directly from the shelf 110b for subsequent transport to a workstation or processing machine on the IC chip manufacturing floor. It is understood that the overhead hoist may alternatively place one or more FOUPs to the shelf 110b.

Like the fixed shelf 110a, the movable shelf 110b may be at substantially the same height above the floor 105 as the overhead hoist transport vehicle 102b. Further, the overhead hoist transport vehicle 102b includes a cowl 103b having an opening formed therethrough to allow the movable shelf 110b holding the FOUP 108b to move to its position below the overhead hoist within the transport vehicle 102b. Once the FOUP 108b is held by the overhead hoist, the shelf 110b moves back to its original position beside the suspended track 106b.

It should be appreciated that the automated material handling system described herein operates under computerized control. For example, the AMHS 100 may comprise a computer system including one or more processors for executing instructions out of a memory. The instructions executed in performing the operations herein described may comprise instructions stored as program code considered part of an operating system, instructions stored as program code considered part of an application, or instructions stored as program code allocated between the operating system and the application. Further, the memory may comprise Random Access Memory (RAM), a combination of RAM and Read Only Memory (ROM), or any other suitable program storage.

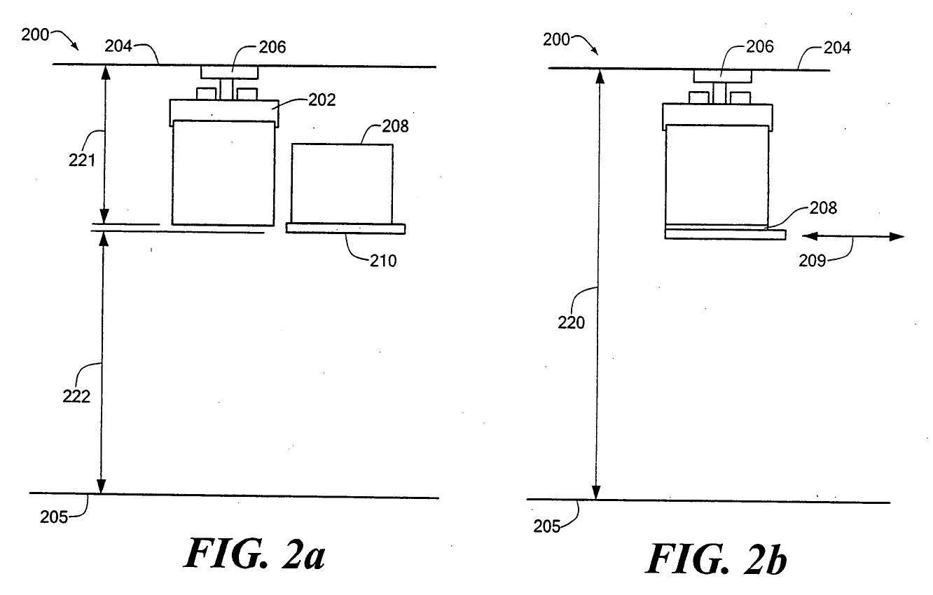

FIGS. 2a-2b depict an Automated Material Handling System (AMHS) 200, which may be employed in the IC chip manufacturing environment 101 of FIG. 1. In the illustrated embodiment, the AMHS 200 includes a suspended track 206, and an overhead hoist transport vehicle 202 configured to travel on the track 206. The overhead hoist transport vehicle 202 is configured to pick/place a FOUP 208 from/to a movable shelf 210. For example, the overhead hoist transport vehicle 202 may extend a distance 221 of about 0.9 m below a ceiling 204, and the movable shelf 210 may be disposed a distance 222 of about 2.6 m above a floor 205. Accordingly, the ceiling 204 may be a distance 220 of about 3.5 m above the floor 205.

In the preferred embodiment, the movable shelf 210 is suspended above the floor 205 of the IC chip manufacturing facility. For example, the movable shelf 210 may be suspended from the structure of the track 206, from the ceiling 204, or from any other suitable structure. Because movable shelves like the shelf 210 may be suspended on either side or on both sides of the track 206, the shelf 210b provides offset Zero Footprint Storage (ZFS) for the FOUP 208, thereby providing more efficient use of space in the IC chip manufacturing environment.

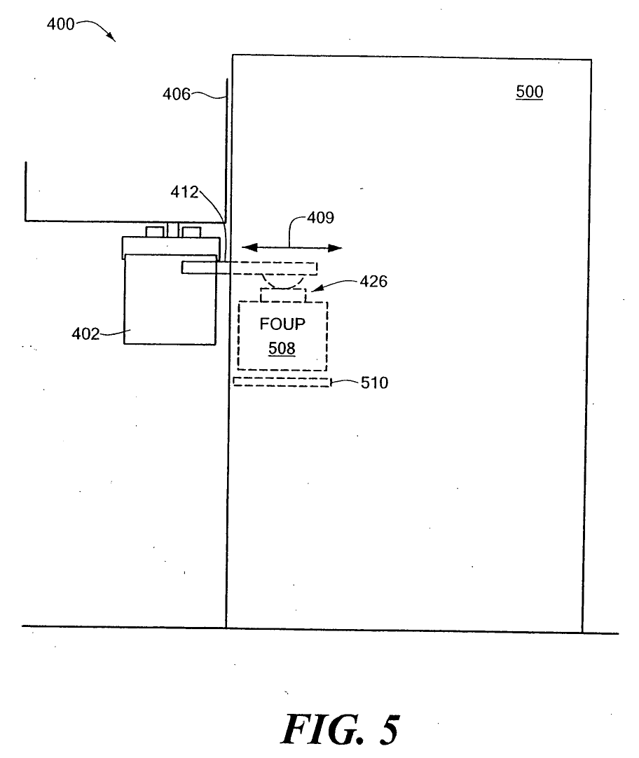

As described above, the overhead hoist transport vehicle 202 is configured to pick/place the FOUP 208 from/to the movable shelf 210. To that end, the overhead hoist transport vehicle 202 moves along the suspended track 206 to a position at the side of the shelf 210. As shown in FIG. 2a, the shelf 210 disposed beside the track 206 may be at substantially the same height as the overhead hoist transport vehicle 202. Next, the shelf 210 moves laterally to a position substantially directly underneath the overhead hoist within the overhead hoist transport vehicle 202, as indicated by directional arrows 209 (see FIG. 2b). The overhead hoist transport vehicle 202 includes a hoist gripper (see, e.g., a hoist gripper 426 of FIG. 5) configured to pick/place the FOUP 208 directly from/to the shelf 210. Once the FOUP 208 is held by the hoist gripper, the overhead hoist transport vehicle 202 may move it to a workstation or processing machine on the IC chip manufacturing floor.

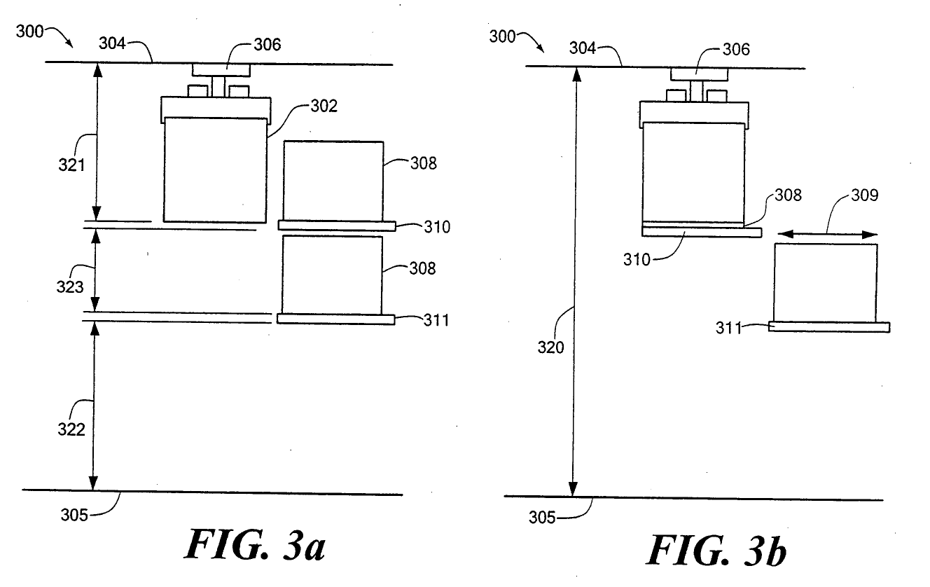

FIGS. 3a-3b depict an Automated Material Handling System (AMHS) 300, which may be employed in the IC chip manufacturing environment 101 of FIG. 1. Like the AMHS 200 (see FIGS. 2a-2b), the AMHS 300 includes a suspended track 306, and an overhead hoist transport vehicle 302 configured to travel on the track 306. However, whereas the overhead hoist transport vehicle 202 included in the AMHS 200 picks/places the FOUP 208 from/to the movable shelf 210 disposed in a single row of shelves, the overhead hoist transport vehicle 302 is configured to pick/place FOUPs 308 from/to selected movable shelves 310-311 disposed in respective rows of shelves. For example, the overhead hoist transport vehicle 302 may extend a distance 321 of about 0.9 m below a ceiling 304, the shelf 310 may be disposed at substantially the same height as the overhead hoist transport vehicle 302, and the shelf 311 may be disposed a distance 323 of about 0.4 m below the shelf 310b and a distance 322 of about 2.6 m above a floor 305. Accordingly, the ceiling 304 may be a distance 320 of about 3.9 m above the floor 305.

Because the movable shelves 310-311 may be suspended from the structure of the track 306, from the ceiling 304, or from any other suitable structure, the shelves 310-311 provide multiple rows or levels of offset Zero Footprint Storage (ZFS) for the FOUPs 308. Further, each row of shelves is substantially directly above or below an adjacent row of shelves, thereby forming at least one shelf array including multiple rows and multiple columns of shelves. It is noted that the top row of shelves in the shelf array (including the shelf 310) may be at substantially the same height as the overhead hoist transport vehicle 302.

In the illustrated embodiment, the overhead hoist transport vehicle 302 is configured to pick/place the FOUPs 308 from/to the movable shelves 310-311. To pick the FOUP 308 from the shelf 310, the overhead hoist transport vehicle 302 moves along the suspended track 306 to a position at the side of the shelf 310. Next, the shelf 310 moves laterally to a position directly underneath the overhead hoist within the overhead hoist transport vehicle 302, as indicated by directional arrows 309 (see FIG. 3b). Like the overhead hoist transport vehicle 202, the overhead hoist transport vehicle 302 includes a hoist gripper (see, e.g., the hoist gripper 426 of FIG. 5) configured to pick/place the FOUP 308 directly from/to the shelf 310. Once the FOUP 308 is picked from the shelf 310 and held by the hoist gripper, the overhead hoist transport vehicle 302 may move it to a workstation or processing machine on the IC chip manufacturing floor.

To pick the FOUP 308 from the shelf 311 in the same column as the shelf 310 but in the row below the shelf 310, the overhead hoist transport vehicle 302 positions itself at the side of the shelf 310. Next, the shelf 311 moves laterally to a position substantially directly underneath the overhead hoist within the overhead hoist transport vehicle 302, as indicated by the directional arrows 309. The overhead hoist is then lowered in a conventional manner toward the shelf 311 to pick the FOUP 308 from the shelf 311 using the hoist gripper. Next, the overhead hoist is raised so that the FOUP 308 is held by the hoist gripper within the overhead hoist transport vehicle 302, which may then move it to a workstation or processing machine on the IC chip manufacturing floor. Finally, the shelf 311 moves back to its original position in the shelf array.

It should be understood that the overhead hoist included in the overhead hoist transport vehicle 302 may access WIP parts stored on selected movable shelves (e.g., the shelves 310-311) disposed in the same column of shelves from the same position on the suspended track 306. In this way, the overhead hoist transport vehicle 302 may access one or more levels of WIP storage from a single track position.

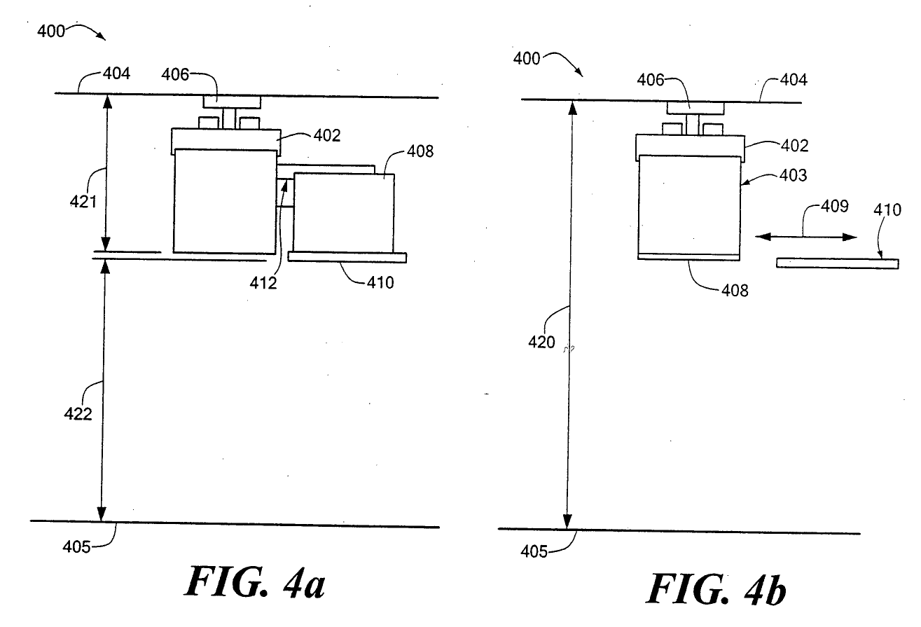

FIGS. 4a-4b depict an Automated Material Handling System (AMHS) 400, which may be employed in the IC chip manufacturing environment 101 of FIG. 1. In the illustrated embodiment, the AMHS 400 includes a suspended track 406, and an overhead hoist transport vehicle 402 configured to travel on the track 406. The overhead hoist transport vehicle 402 is configured to pick/place a FOUP 408 from/to a passive or fixed shelf 410. For example, the overhead hoist transport vehicle 402 may extend a distance 421 of about 0.9 m below a ceiling 404, and the fixed shelf 410a may be disposed a distance 422 of about 2.6 m above a floor 405. It is noted that the shelf 410 may be at substantially the same height above the floor as the overhead hoist transport vehicle 402. Accordingly, the ceiling 404 may be a distance 420 of about 3.5 m above the floor 405.

It should be understood that a plurality of fixed shelves like the shelf 410 may be disposed in a single row or in multiple rows beside and substantially parallel to the track 406. Moreover, one or more rows of fixed shelves may be located on either side or on both sides of the track 406. Because multiple rows of fixed shelves may be suspended beside the track 406 from the track structure, from the ceiling 404, or from any other suitable structure, the fixed shelves provide multiple levels of offset Zero Footprint Storage (ZFS) for the FOUP 408.

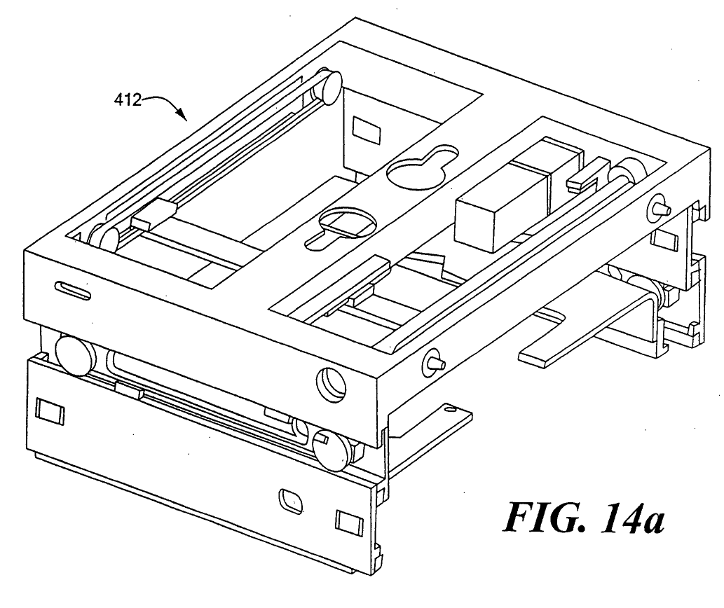

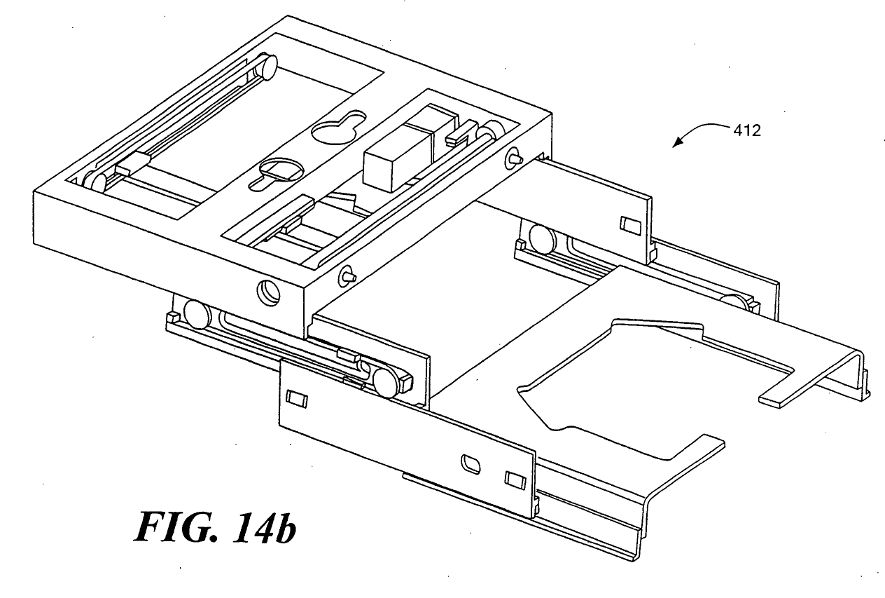

In the illustrated embodiment, the overhead hoist included in the overhead hoist transport vehicle 402 is mounted on a translating stage 412 configured to move the hoist to a position beside the transport vehicle 402 and substantially directly above a selected fixed shelf. FIG. 14a depicts the translating stage 412 in a retracted configuration, and FIG. 14b depicts the translating stage 412 in a laterally extended configuration. To pick the FOUP 408 from the shelf 410 (see FIGS. 4a-4b), the overhead hoist transport vehicle 402 moves along the suspended track 406 to a position at the side of the shelf 410. Next, the translating stage 412 moves laterally to the position above the shelf 410, as indicated by directional arrows 409 (see FIG. 4a). A hoist gripper 426 (see FIG. 5) is then operated to pick/place the FOUP 408 directly from/to the shelf 410. Once the FOUP 408 is picked from the shelf 410 and held by the hoist gripper 426, the translating stage 412 moves back to its original position within the overhead hoist transport vehicle 402. It is noted that as the translating stage 412 returns to its original position within the transport vehicle 402, the FOUP 408 moves into the transport vehicle 402 through a cowl opening 403 (see FIG. 4b). The overhead hoist transport vehicle 402 may then move the FOUP 408 to a workstation or processing machine on the IC chip manufacturing floor.

It is understood that the overhead hoist included in the overhead hoist transport vehicle 402 may access WIP parts disposed on selected fixed shelves (e.g., the shelf 410a) disposed in the same column of shelves from the same position on the suspended track 406. For example, to access a FOUP disposed on a fixed shelf in the same column as the shelf 410 but in a row below the shelf 410, the overhead hoist may be lowered in the conventional manner to a suitable level at the side of the lower shelf, and the translating stage 412 may be moved laterally to allow the hoist gripper 426 to pick/place the FOUP from/to the shelf. In this way, the overhead hoist transport vehicle 402 may access one or more levels of WIP storage from a single track position.

FIG. 5 depicts an illustrative application of the AMHS 400 (see also FIGS. 4a-4b), in which the AMHS 400 is employed in conjunction with a WIP storage unit 500 (a “stocker”). In the illustrated embodiment, the stocker 500 includes a plurality of storage bins such as a shelf 510 disposed within the stocker housing. The storage bins within the stocker 500 are rotated around a central axis and positioned to a storage unit location that allows extraction by the overhead hoist transport vehicle 402. To pick a FOUP 508 from the shelf 510, the overhead hoist transport vehicle 402 moves along the suspended track 406 to a position at the side of the shelf 510. Next, the translating stage 412 moves laterally to a position substantially directly above the shelf 510, as indicated by the directional arrows 409. The hoist gripper 426 is then operated to pick the FOUP 508 directly from the shelf 510 to extract the FOUP 508 from the stocker 500. It is understood that the hoist gripper 426 may alternatively be employed to place a FOUP to the shelf 510 within the stocker 500. Once the FOUP 508 is picked from the shelf 510 and held by the hoist gripper 426, the translating stage 412 moves back to its original position within the overhead hoist transport vehicle 402, which subsequently moves the FOUP 408 to a workstation or processing machine on the IC chip manufacturing floor.

It is noted that the overhead hoist of FIG. 5 may alternatively pick/place a FOUP from/to a shelf external to the stocker 500. For example, the stocker 500 may include one or more movable shelves, in which each shelf is configured to move laterally from a first position inside the stocker 500 to a second position outside the stocker 500 to provide the overhead hoist access to the FOUP. Once the FOUP is picked from the shelf and held by the hoist gripper 426, the shelf moves back to its original position within the stocker 500. Using the overhead hoist of FIG. 5 to access FOUPs directly from the stocker 500 obviates the need for traditional I/O mechanisms such as the input/output ports 118-119 (see FIG. 1), thereby reducing system costs.

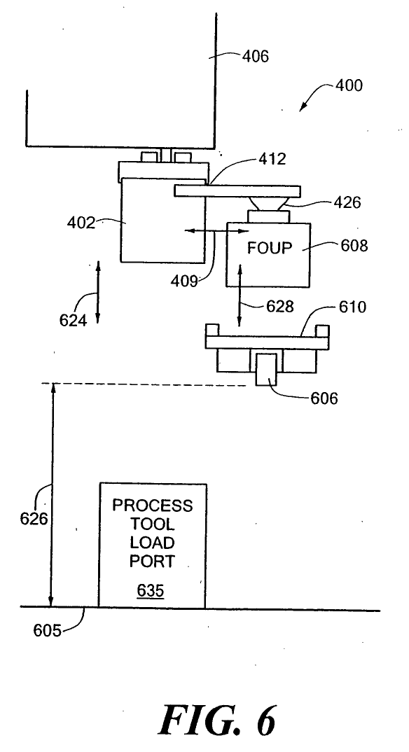

FIG. 6 depicts an illustrative application of the AMHS 400 (see also FIGS. 4a-4b), in which the AMHS 400 is employed in conjunction with an overhead WIP conveyor 610. In the illustrated embodiment, the overhead hoist mounted on the translating stage 412 is employed to pick/place a FOUP 608 directly from/to the WIP conveyor 610, which is configured to travel along a rail 606. It should be understood that the rail 606 extends in a direction perpendicular to the plane of the drawing of FIG. 6. The overhead hoist may also be employed to pick the FOUP 608 from the rail-based conveyor 610, and to place the FOUP 608 to, e.g., a process tool load port 635, and vice versa. For example, the overhead hoist transport vehicle 402 may be disposed a distance 624 of about 0.35 m above the rail-based conveyor 610. Further, the overhead rail 606 may be a distance 626 of about 2.6 m above a floor 605 of the IC manufacturing facility.

It is noted that overhead hoist transport vehicles traveling on suspended tracks, e.g., the track 406, are normally employed to provide “hop-to-hop” transport of FOUPs between adjacent workstations and processing machines. In contrast, the rail-based conveyor 610 may be employed to provide express transport of FOUPs between workstations and processing machines located a substantial distance apart on the IC chip manufacturing floor. By using the rail-based conveyor 610 to move FOUPs substantial distances across the IC chip manufacturing facility, transport system congestion can be significantly reduced.

As described above, the overhead hoist mounted on the translating stage 412 may be employed to pick/place the FOUP 608 from/to the rail-based conveyor 610. To that end, the overhead hoist transport vehicle 402 and the rail-based conveyor 610 move so that the transport vehicle 402 with the FOUP 608 disposed therein is positioned at the side of the conveyor 610. Next, the translating stage 412 moves laterally to position the FOUP 608 substantially directly above the surface of the conveyor 610, as indicated by the directional arrows 409. The overhead hoist is then lowered in a conventional manner toward the conveyor 610, as indicated by directional arrows 628. Next, the overhead hoist is operated to place the FOUP 608 to the conveyor 610, which subsequently transports the FOUP 608 across the IC chip manufacturing floor.

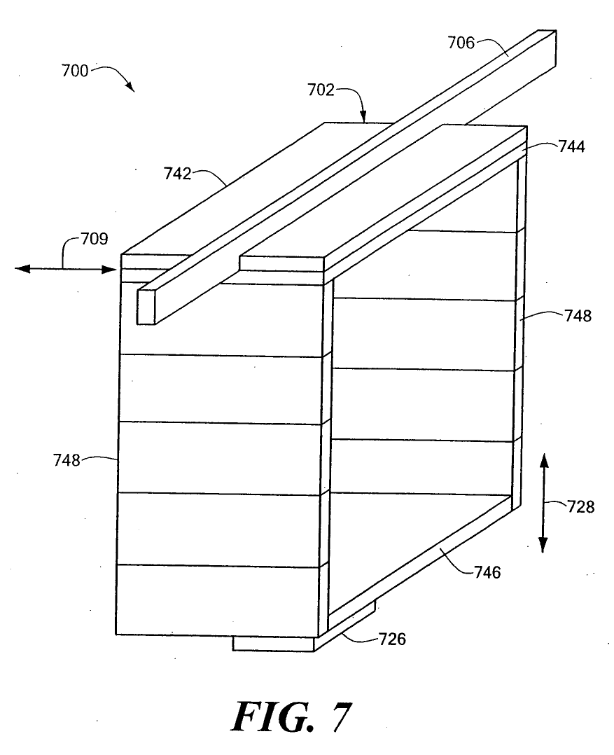

FIG. 7 depicts an alternative embodiment 700 of the AMHS 400 of FIGS. 4a-4b. Like the AMHS 400, the AMHS 700 is configured to pick/place a FOUP from/to a passive or fixed shelf. In the illustrated embodiment, the AMHS 700 includes a suspended track 706 and an overhead hoist transport vehicle 702 supported by the track 706. As shown in FIG. 7, the overhead hoist transport vehicle 702 includes a proximal end portion 744, a distal end portion 746, and suspension elements 748 coupled between the proximal and distal ends 744 and 746. The overhead hoist transport vehicle 702 further includes a hoist gripper 726 mounted at the distal end 746, and a transport member 742 movably coupled to the proximal end 744 and configured to allow the transport vehicle 702 to travel on the track 706.

Specifically, the proximal end 744 is configured to move laterally relative to the transport member 742 in a direction substantially perpendicular to the track 706, as indicated by directional arrows 709. For example, the proximal end 744 may operate as a Y-table, a pneumatic mechanism, a stepper servo mechanism, or any other suitable mechanism providing a relatively long lateral excursion. Further, the distal end 746 is configured to move in a vertical direction, as indicated by directional arrows 728. For example, the distal end 746 may be coupled at the ends of the suspension elements 748, which may be configured to telescope to allow the distal end 746 to move in the desired vertical direction. Accordingly, the combination of the proximal end 744 and the suspension elements 748 allows the distal end 746 carrying the hoist gripper 726 to move with 2-degrees-of-freedom, as specified by the directional arrows 709 and 728.

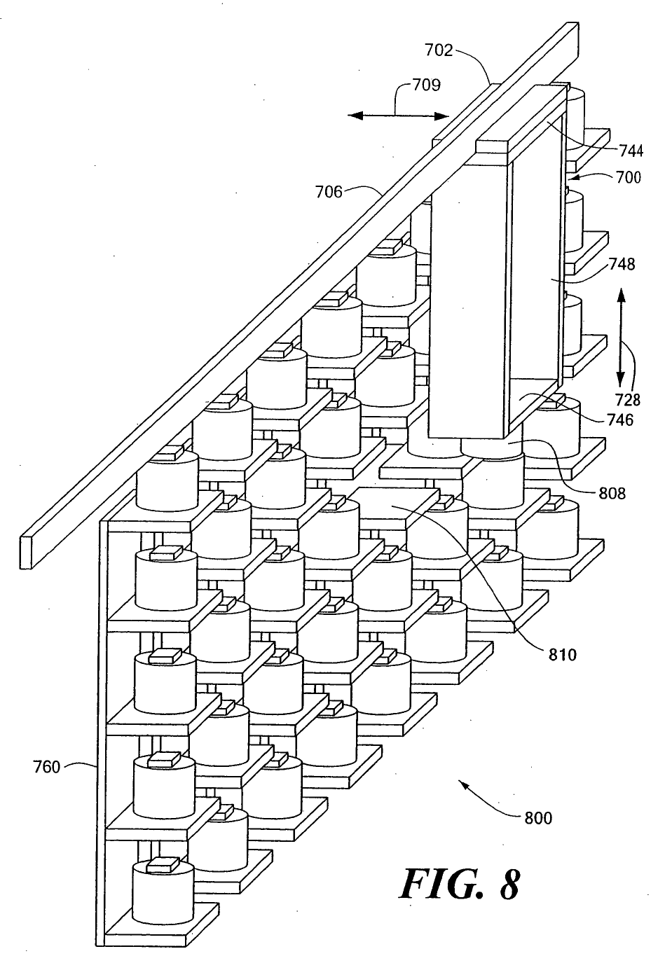

FIG. 8 depicts the AMHS 700 of FIG. 7 employed in conjunction with an array 800 of passive or fixed shelves. In the illustrated embodiment, the overhead hoist transport vehicle 702 is configured to pick/place FOUPs, e.g., a FOUP 808, from/to selected shelves within the array 800, which includes multiple rows and multiple columns of fixed shelves such as a shelf 810. As shown in FIG. 8, the shelf array 800 is disposed beside and substantially parallel to the suspended track 706. Further, each shelf is attached along a single edge to a vertical support member 760 that may be anchored to the floor, and adjacent columns of shelves are spaced to allow the respective suspension elements 748 to fit in the spaces between the adjacent columns. It is noted that in this configuration, the FOUPs 808 are exposed for manual access, if desired.

For example, to pick the FOUP 808 from the shelf 810, the overhead hoist transport vehicle 702 moves along the suspended track 706 to a position at the side of the column including the shelf 810. Next, the distal end 746 including the hoist gripper 726 moves down, as indicated by the directional arrows 728, to a position at the side of the shelf 810 holding the FOUP 808. The proximal end 742 then moves laterally, as indicated by the directional arrows 709, to position the hoist gripper 726 substantially directly above the shelf 810 beside the track 706. It is noted that as the proximal end 742 performs its lateral movement, the respective suspension elements 748 are accommodated in the spaces on each side of the column of shelves.

Once the FOUP 808 is picked from the shelf 810 by the hoist gripper 726, the proximal end 742 moves back to its original position underneath the track 706, thereby allowing the distal end 746 with the hoist gripper 726 holding the FOUP 808 to move back up toward the track 706. The transport member 702 may then move the FOUP 808 to a workstation or processing machine on the IC chip manufacturing floor. It should be understood that the overhead hoist transport vehicle 702 may access WIP parts stored on selected shelves disposed in the same column of shelves from the same position on the suspended track 706. In this way, the overhead hoist transport vehicle 702 may access one or more levels of WIP storage from a single track position.

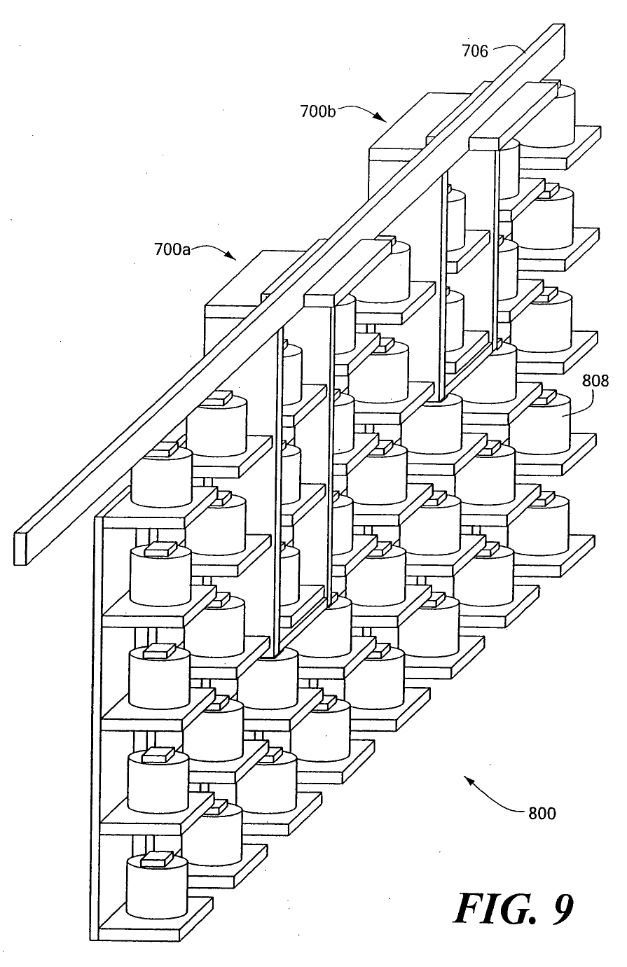

FIG. 9 depicts a plurality of Automated Material Handling Systems (AMHS) 700a-700b employed in conjunction with the array of shelves 800. It should be understood that each of the AMHSs 700a-700b is like the AMHS 700 of FIG. 7. In the illustrated embodiment, the AMHSs 700a-700b are configured to travel on the single suspended track 706 to allow simultaneous accesses of the FOUPs 808 stored in the shelf array 800, thereby assuring high system throughput.

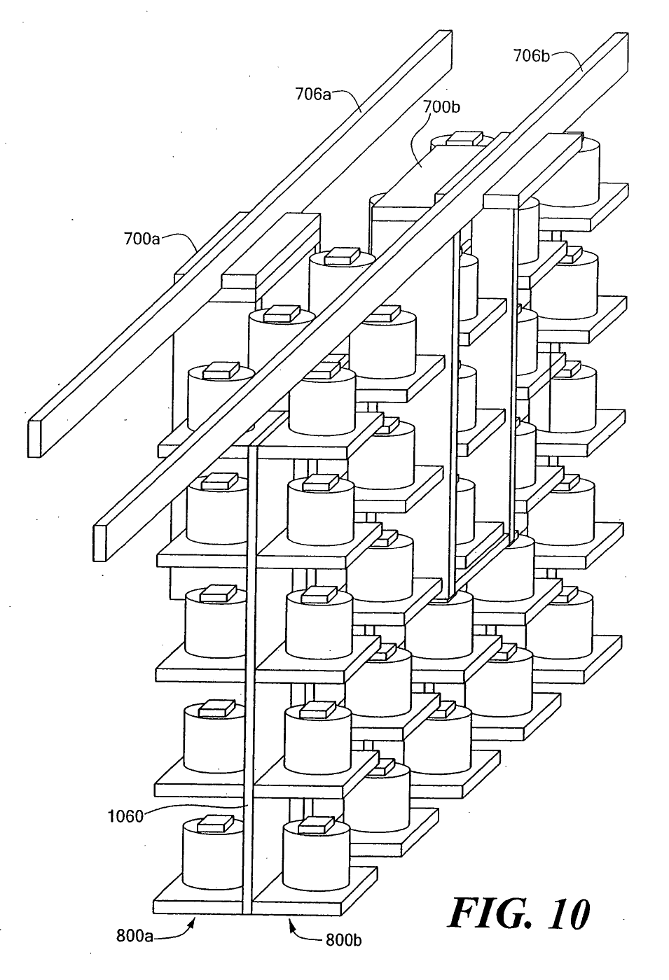

FIG. 10 depicts the AMHSs 700a-700b employed in conjunction with two arrays 800a-800b of shelves in a back-to-back configuration for increased storage density. As shown in FIG. 10, each shelf in the shelf arrays 800a-800b is attached along a single edge to a vertical support member 1060, which may be anchored to the floor. It should be understood that each of the shelf arrays 800a-800b is like the shelf array 800 (see FIG. 8) in that adjacent columns of shelves are spaced to allow the respective suspension elements 748 to fit in the spaces between the adjacent columns. In the illustrated embodiment, the AMHSs 700a-700b are configured to travel on suspended tracks 706a-706b, respectively, to allow simultaneous accesses of the FOUPs stored in the shelf arrays 800a-800b, thereby assuring high system throughput. Because the system configurations of FIGS. 8-10 do not require robots for accessing the FOUPs (as in conventional material handling systems), floor space requirements and system costs are reduced, while system reliability is enhanced.

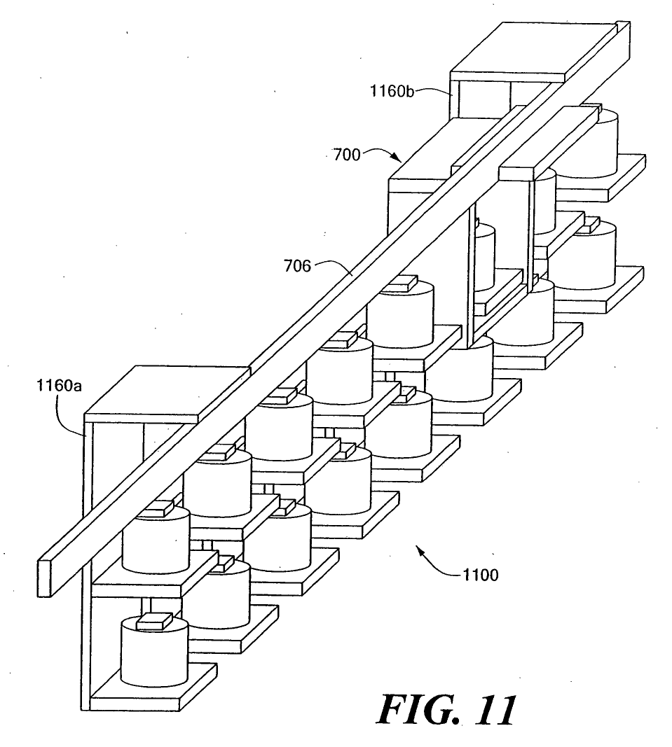

FIG. 11 depicts the AMHS 700 of FIG. 7 employed in conjunction with an array 1100 of fixed shelves. Like the shelf array 800 (see FIG. 8), the shelf array 1100 is disposed beside and substantially parallel to the suspended track 706. Further, each shelf is attached along a single edge to one or more vertical support members 1160a-1160b, and adjacent columns of shelves are spaced to allow the respective suspension elements 748 to fit in the spaces between the adjacent columns. However, whereas the shelf array 800 is anchored to the floor, the shelf array 1100 is suspended from the structure of the track 706 by the support members 1160a-1160b. It is understood that the shelf array 1100 may alternatively be suspended from the ceiling or any other suitable structure. As a result, the shelf array 1100 provides multiple rows or levels of offset Zero Footprint Storage (ZFS) for the FOUPs stored therein.

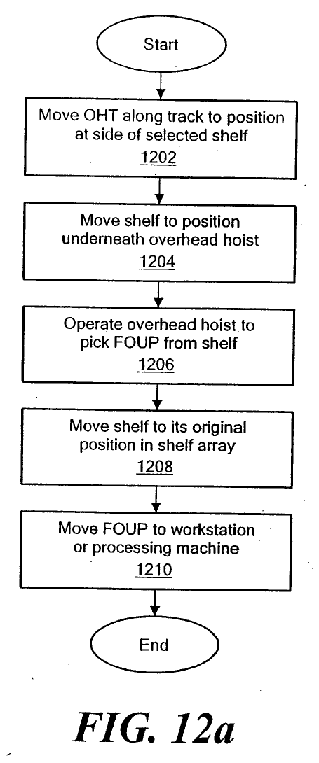

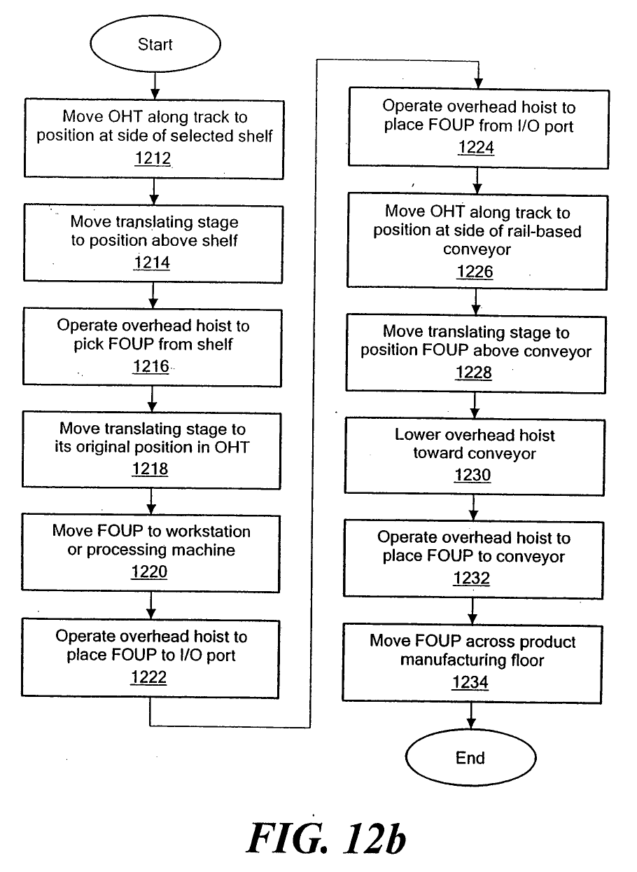

A first method of operating the presently disclosed automated material handling system is illustrated by reference to FIG. 12a. As depicted in step 1202, an Overhead Hoist Transport (OHT) vehicle moves along a suspended track to a position at the side of a selected movable shelf in a shelf array. The shelf has at least one FOUP disposed thereon. Next, the shelf moves, as depicted in step 1204, to a position underneath an overhead hoist included in the OHT vehicle. The overhead hoist is then operated, as depicted in step 1206, to pick the FOUP from the shelf. Next, the shelf moves, as depicted in step 1208, back to its original position in the shelf array. Finally, the OHT vehicle moves, as depicted in step 1210, the FOUP to a workstation or processing machine on the product manufacturing floor.

A second method of operating the presently disclosed automated material handling system is illustrated by reference to FIG. 12b. As depicted in step 1212, an OHT vehicle moves along a suspended track to a position at the side of a selected fixed shelf in a shelf array. The shelf has at least one FOUP disposed thereon. Next, a translating stage having an overhead hoist mounted thereon moves, as depicted in step 1214, to a position above the shelf. The overhead hoist is then operated, as depicted in step 1216, to pick the FOUP from the shelf. Next, the translating stage moves, as depicted in step 1218, back to its original position in the OHT vehicle. The OHT vehicle then moves, as depicted in step 1220, the FOUP to a workstation or processing machine on the product manufacturing floor. Next, the overhead hoist is operated, as depicted in step 1222, to place the FOUP to an I/O port of the processing machine, including moving the translating stage to a position above the I/O port, placing the FOUP to the I/O port, and moving the translating stage back to its original position within the OHT vehicle. The overhead hoist is then operated, as depicted in step 1224, to pick the FOUP from the I/O port of the processing machine. Next, the OHT vehicle moves, as depicted in step 1226, to a position at the side of a rail-based conveyor. The translating stage then moves, as depicted in step 1228, to position the FOUP above the rail-based conveyor. Next, the overhead hoist holding the FOUP is lowered, as depicted in step 1230, toward the conveyor, and the overhead hoist is operated, as depicted in step 1232, to place the FOUP to the conveyor. After the translating stage returns to its original position within the OHT vehicle, the rail-based conveyor moves, as depicted in step 1234, to transport the FOUP an extended distance across the product manufacturing floor.

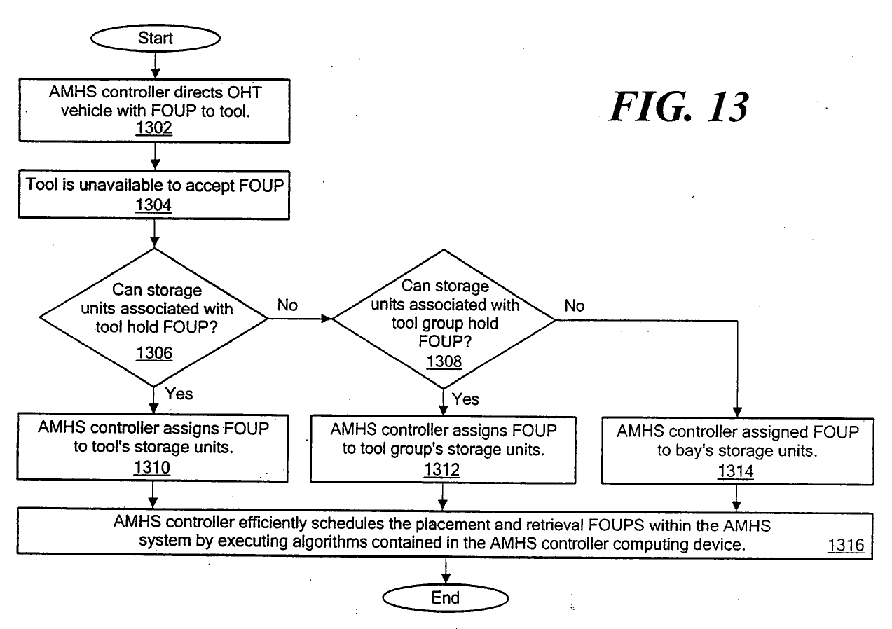

A method of controlling the presently disclosed automated material handling system is illustrated by reference to FIG. 13. It is noted that storage locations may be configured to handle overflow FOUPs from a particular process tool, from a group of process tools, or from a semiconductor bay. A storage unit is one or more storage locations. An AMHS controller will attempt to store the FOUP near the destination tool and handle the storage within the storage location unit to optimize quick retrieval and deposit of other FOUPs within the unit. As depicted in step 1302, an AMHS controller directs an overhead hoist transport vehicle with a FOUP to a process tool. Next, the process tool is unavailable to accept the FOUP, as depicted in step 1304. A determination is then made, as depicted in step 1306, as to whether storage units associated with the process tool can hold the FOUP. If so, the AMHS controller assigns, as depicted in step 1310, the FOUP to the process tool's storage units. Otherwise, a determination is made, as depicted in step 1308, as to whether storage units associated with the process tool group can hold the FOUP. If so, the AMHS controller assigns, as depicted in step 1312, the FOUP to the process tool group's storage units. Otherwise, the AMHS controller assigns, as depicted in step 1314, the FOUP to a semiconductor bay's storage units. Following each of the steps 1310, 1312, and 1314, the AMHS controller efficiently schedules, as depicted in step 1316, the placement and retrieval of FOUPs within the AMHS system by executing algorithms included in the AMHS controller computing device.

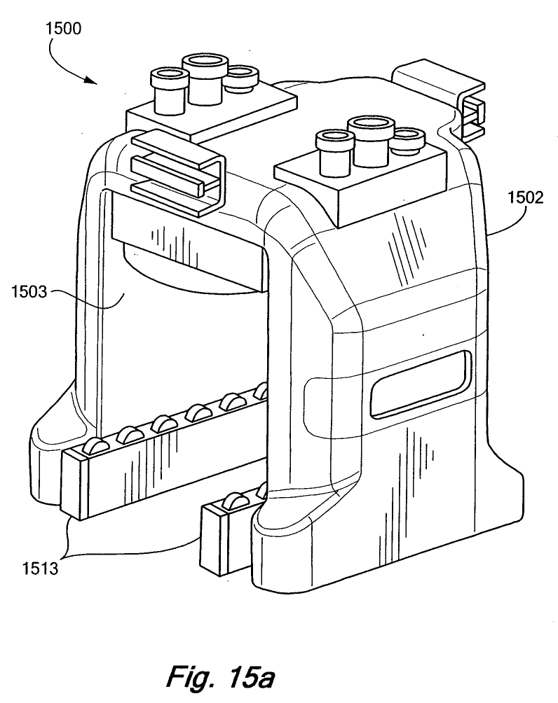

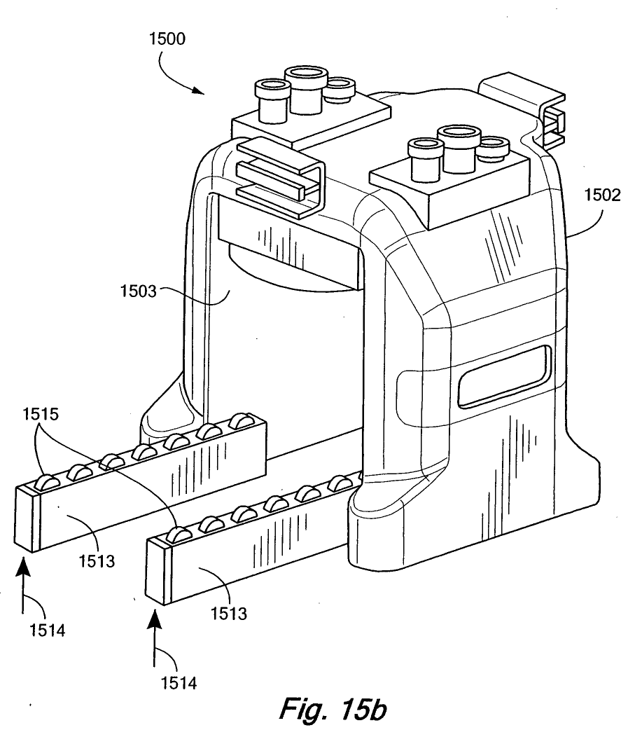

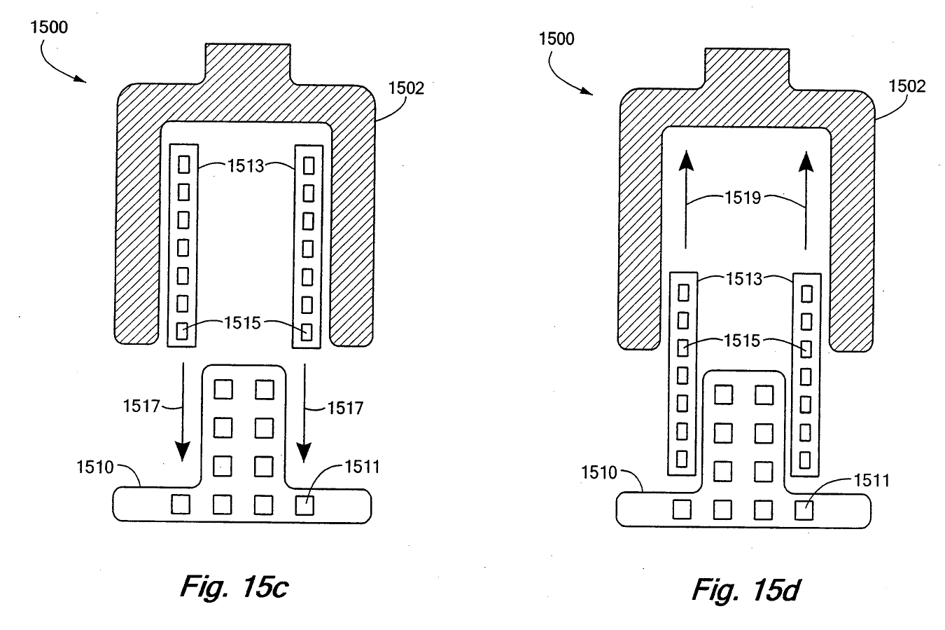

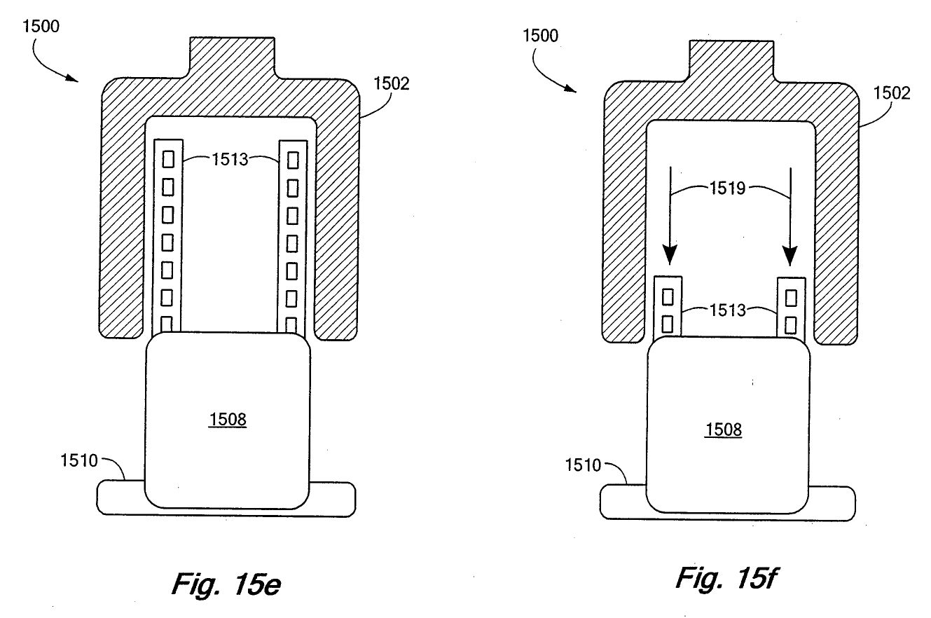

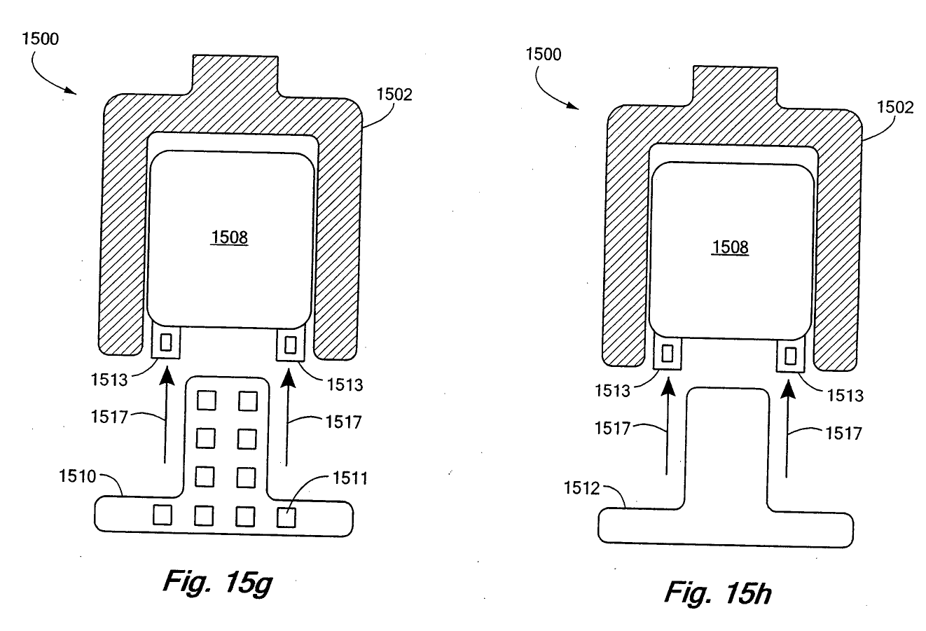

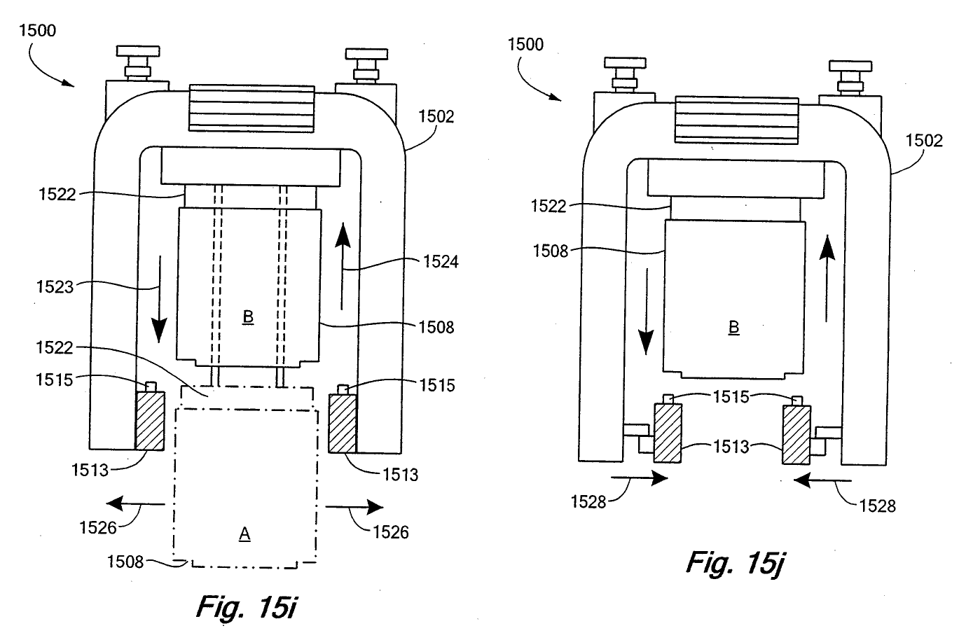

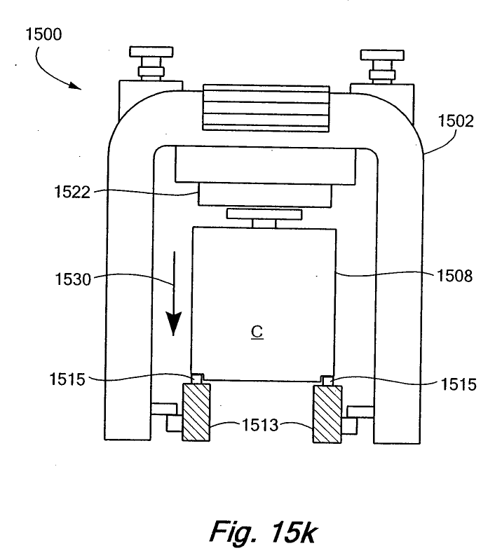

Having described the above illustrative embodiments, other alternative embodiments or variations may be made. For example, FIGS. 15a-15b depict another alternative embodiment 1500 of the Automated Material Handling System (AMHS) 400 of FIGS. 4a-4b. Specifically, the AMHS 1500 includes an overhead hoist transport vehicle 1502 configured to travel on an overhead track (not shown) to a position adjacent a shelf, such as a passive or fixed shelf 1510 (see FIGS. 15c-15g), located beside the track. Like the overhead hoist transport vehicle 402 (see FIGS. 4a-4b), the transport vehicle 1502 is configured to pick/place a FOUP 1508 or any other suitable material unit from/to the shelf 1510 disposed beside the track. It is noted that the shelf 1510 may be suspended or otherwise disposed above, below, or at the same height as the transport vehicle 1502 relative to the floor. It is understood that a plurality of shelves like the shelf 1510 may be disposed in a single row or in multiple rows beside the track. Moreover, one or more rows of shelves may be located on either side or on both sides of the track. Because multiple rows of shelves may be suspended beside the track either from the track structure, from the ceiling, or from any other suitable structure, the shelves provide multiple levels of offset Zero Footprint Storage (ZFS) for the FOUP 1508.

In the illustrated embodiment, the overhead hoist transport vehicle 1502 includes a pair of translating arms 1513. As shown in FIGS. 15a-15b, the AMHS 1500 is configured for simultaneously translating the arms 1513 to a retracted position within the transport vehicle 1502 (see FIG. 15a), or simultaneously translating the arms 1513 to an extended position outside of the transport vehicle 1502 (see FIG. 15b). Each of the translating arms 1513 includes a plurality of active rollers such as the active roller 1515 disposed along an upper edge of the respective arm 1513. In addition, the shelf 1510 includes a plurality of passive rollers such as the passive roller 1511 (see FIGS. 15c-15d) disposed on a surface thereof. Each of the active rollers is at least partially exposed along the upper edge of one of the arms 1513, and, similarly, each of the passive rollers is at least partially exposed on the surface of the shelf 1510. The AMHS 1500 is configured for simultaneously rotating the plurality of active rollers in a clockwise or counterclockwise direction to convey or otherwise move a FOUP along the upper edges of the arms 1513 while picking/placing the FOUP from/to the fixed shelf 1510. The picking/placing of the FOUP from/to the fixed shelf 1510 is facilitated by the plurality of passive rollers, which allow the FOUP to glide easily along the surface of the shelf 1510 while being moved by the active rollers along the translating arms 1513.

It is noted that mechanisms for translating the arms 1513 between the extended and retracted positions, and for rotating the plurality of active rollers disposed along the upper edges of the arms 1513, may be designed by one of ordinary skill in this art using conventional techniques. The details of such conventional mechanisms have been omitted from FIGS. 15a-15k for clarity of illustration.

As described above, the AMHS 1500 is configured for simultaneously translating the arms 1513 to a retracted position within the overhead hoist transport vehicle 1502 (see FIG. 15a), and for simultaneously translating the arms 1513 to an extended position outside of the transport vehicle 1502 (see FIG. 15b). FIGS. 15c-15d depict an overhead cross-sectional view of the transport vehicle 1502, showing the translating arms 1513 in their retracted and extended positions, respectively. When the transport vehicle 1502 is positioned adjacent the shelf 1510, the translating arms 1513 may be moved from their retracted positions to their extended positions outside of the transport vehicle 1502, as indicated by directional arrows 1517 (see FIG. 15c). As shown in FIG. 15d, the translating arms 1513 and the shelf 1510 are configured to allow the arms 1513 to be disposed near opposing sides of the shelf 1510 while in their extended positions. The translating arms 1513 may then be moved from their extended positions to their retracted positions within the transport vehicle 1502, as indicated by directional arrows 1519 (see FIG. 15d).

FIGS. 15e-15h depict an illustrative mode of operating the Automated Material Handling System (AMHS) 1500. As shown in FIG. 15e, the overhead hoist transport vehicle 1502 is positioned adjacent the fixed shelf 1510, which has the FOUP 1508 disposed thereon. Specifically, FIG. 15e depicts the translating arms 1513 in their retracted positions within the transport vehicle 1502. In addition, the width of the FOUP 1508 is slightly larger than the width of the shelf 1510 to allow portions of the bottom surface of the FOUP 1508 to overhang opposing sides of the shelf 1510. In the illustrated embodiment, the width of the overhanging portions of the FOUP 1508 is approximately equal to the width of the upper edges of the arms 1513. Next, the translating arms 1513 are moved from their retracted positions to their extended positions outside of the transport vehicle 1502, as indicated by the directional arrows 1519 (see FIG. 15f). In the presently disclosed embodiment, while the arms 1513 are being moved from their retracted positions to their extended positions, the rollers, such as the rollers 1515 disposed along the upper edges of the respective arms 1513, may be allowed to make contact with and to rotate freely along the overhanging portions of the bottom surface of the FOUP 1508. While the translating arms 1513 move to their extended positions, the AMHS 1500 is not actively rotating the rollers disposed along the arms. When the translating arms 1513 come to rest in the extended positions, the transport vehicle 1502 may be raised slightly to raise the arms 1513, as indicated by directional arrows 1514 (see FIG. 15b), thereby picking the FOUP 1508 from the shelf 1510. The AMHS 1500 then rotates the active rollers to move the FOUP 1508 along the arms from the shelf 1510, toward the transport vehicle 1502, and further onto the respective arms 1513. While the active rollers are rotating, the FOUP 1508 glides easily along the surface of the shelf 1510 due to the passive rollers disposed on the shelf surface. When the FOUP 1508 approaches proximal ends of the arms 1513 within the transport vehicle 1502, the AMHS 1500 stops rotating the active rollers, and locks them in place to prevent further movement of the FOUP 1513 along the arms 1513. Finally, the translating arms 1513 are moved from their extended positions to their retracted positions, as indicated by the directional arrows 1517 (see FIG. 15g), thereby moving the FOUP 1508 through a cowl 1503 (see FIGS. 15a-15b) to a position within the transport vehicle 1502.

To place the FOUP 1508 or any other suitable material unit on the shelf 1510, the overhead hoist transport vehicle 1502 is again positioned adjacent the shelf 1510, and the translating arms 1513 with the FOUP 1508 disposed thereon are moved to their extended positions. The AMHS 1500 then rotates the active rollers to move the FOUP 1508 along the arms 1513, away from the transport vehicle 1502, and toward the shelf 1510. While the active rollers are rotating, the FOUP 1508 may glide easily along the surface of the shelf 1510 due to the passive rollers disposed on the shelf surface. When the FOUP 1508 approaches distal ends of the arms 1513 relative to the transport vehicle 1502, the AMHS 1500 stops rotating the active rollers, and locks them in place to prevent further movement of the FOUP 1513 along the arms 1513. Next, the transport vehicle 1502 may be lowered slightly to lower the translating arms 1513, thereby removing the FOUP 1508 from the arms and placing it on the shelf 1510. Finally, the translating arms 1513 are moved from their extended positions back to their retracted positions within the transport vehicle 1502.

In still another alternative embodiment, the overhead hoist transport vehicle 1502 may pick/place the FOUP 1508 or any other suitable material unit from/to a fixed shelf 1512 (see FIG. 15h), which does not include any rollers on a surface thereof. In this embodiment, while picking the FOUP 1508 from the shelf 1512, the overhead hoist transport vehicle 1502 is raised a sufficient distance to allow the translating arms 1513 to lift the FOUP 1508 from the shelf 1512, thereby allowing the FOUP 1508 to clear the shelf 1512 when the arms 1513 are subsequently moved from their extended positions to their retracted positions within the transport vehicle 1502. While placing the FOUP 1508 on the shelf 1512, the transport vehicle 1502 is positioned to allow the arms 1513 to move the FOUP 1508 over the shelf 1512 without contacting the shelf surface, and is subsequently lowered to remove the FOUP 1508 from the arms 1513, thereby placing the FOUP 1508 on the shelf 1512.

In yet another embodiment, the shelf 1510 or 1512 (see, e.g., FIGS. 15g-15h) may be configured as a moving shelf. In this embodiment, the moving shelf is configured to move laterally from a first position beside the track to a second position substantially directly underneath the overhead hoist transport vehicle 1502. Further, the translating arms 1513 remain in their retracted positions within the transport vehicle 1502, and the active rollers along the arms 1513 are locked in place. To pick the FOUP 1508 or any other suitable material unit from the moving shelf, the transport vehicle 1502 is positioned adjacent the shelf, which has the FOUP 1508 disposed thereon. Next, the shelf is moved from its position beside the track to a position substantially directly underneath the transport vehicle 1502. When the shelf is positioned underneath the transport vehicle 1502, the retracted arms 1513 are moved laterally, as indicated by directional arrows 1526 (see FIG. 15i), to positions against the interior walls of the transport vehicle 1502, thereby providing sufficient clearance for subsequent movement of the FOUP 1508 between the arms 1513. It is noted that mechanisms for laterally moving the arms 1513, as indicated by the directional arrows 1526, 1528 (see FIGS. 15i-15j), may be designed by one of ordinary skill in this art using conventional techniques. Next, an overhead hoist 1522 included in the transport vehicle 1502 is lowered, as indicated by a directional arrow 1523 (see FIG. 15i), and the hoist 1522 is operated to pick the FOUP 1508 directly from the shelf. The overhead hoist 1522 is then raised, as indicated by a directional arrow 1524, to move the FOUP 1508 from position A underneath the transport vehicle 1502 to position B within the transport vehicle 1502. Next, the retracted arms 1513 are again moved laterally, as indicated by directional arrows 1528, away from the interior walls of the transport vehicle 1502 to positions underneath the FOUP 1508 (see FIG. 15j). The hoist 1522 is then lowered, as indicated by a directional arrow 1530, to move the FOUP 1508 from position B to position C (see FIG. 15k). Next, the overhead hoist 1522 is operated to release the FOUP 1508, thereby allowing the FOUP 1508 to rest on and be supported by the arms 1513 within the transport vehicle 1502.

To place the FOUP 1508 or any other suitable material unit on the moving shelf, the transport vehicle 1502 is again positioned adjacent the shelf. Next, the shelf is moved from its position beside the track to a position substantially directly underneath the transport vehicle 1502. The overhead hoist 1522 is then lowered, as indicated by the directional arrow 1530 (see FIG. 15k), and operated to pick the FOUP 1508 from the arms 1513. Next, the arms 1513 are moved laterally, as indicated by the directional arrows 1526 (see FIG. 15i), to positions against the interior walls of the transport vehicle 1502, thereby providing sufficient clearance for the FOUP 1508 to move between the arms 1513. The hoist 1522 is then lowered, as indicated by the directional arrow 1523, to move the FOUP 1508 from within the transport vehicle 1502 to a position (e.g., position A) underneath the transport vehicle 1502. Next, the hoist 1422 is operated to place the FOUP 1508 on the shelf, and is subsequently raised to a position within the transport vehicle 1502. The shelf with the FOUP 1508 disposed thereon is then moved from its position underneath the transport vehicle 1502 to its original position beside the track.

In addition, it was described that the presently disclosed automated material handling system includes overhead hoist transport vehicles configured to move overhead hoists for accessing carriers such as Front opening Unified Pods (FOUPs) in an IC chip manufacturing environment. However, it should be appreciated that the above-described automated material handling system may be employed in any suitable environment in which articles are stored and moved from place to place. For example, the automated material handling system described herein may be employed in an automobile manufacturing facility, and the WIP parts stored and moved by the system may comprise automobile parts.

It will also be appreciated by those of ordinary skill in the art that further modifications to and variations of the above-described system and method of accessing one or more levels of shelves by an overhead hoist transport vehicle from a single track position may be made without departing from the inventive concepts disclosed herein. Accordingly, the invention should not be viewed as limited except as by the scope and spirit of the appended claims.

What is claimed is:

1. An automated material handling system, comprising:
at least one overhead hoist transport subsystem including an overhead track, at least one translating arm configured to support at least one material unit, and an overhead hoist transport vehicle configured to carry the at least one translating arm to a plurality of track locations along the overhead track, and to lower and raise the at least one translating arm to a plurality of levels, each level corresponding to at least one of the track locations,
wherein the at least one translating arm includes at least one mechanism for conveying at least one material unit along a length of the arm; and
at least one material storage location configured to store the at least one material unit, the at least one material storage location being disposed at a predetermined level on a first side of the track,
wherein the overhead hoist transport vehicle is further operative to carry the at least one translating arm along the overhead track to a track location adjacent the material storage location, and to perform at least one of lowering and raising the at least one translating arm for positioning the translating arm at approximately the predetermined level of the material storage location, and
wherein the at least one translating arm is configured, at least while being positioned at the approximate level of the material storage location, to move from a first position within the overhead hoist transport vehicle to a second position outside of the vehicle by moving laterally toward the first side of the overhead track, thereby allowing the at least one conveying mechanism to move at least one material unit from the material storage location onto at least a portion of the length of the arm, or to move at least one material unit from the arm to the material storage location.

2. The system of claim 1 wherein the at least one translating arm is further configured, at least while being positioned at the approximate level of the material storage location, to move from the second position outside of the overhead hoist transport vehicle to the first position within the vehicle, thereby moving the at least one material unit disposed thereon into the vehicle.

3. The system of claim 1 wherein the at least one material storage location comprises at least one shelf,
wherein the at least one translating arm comprises a pair of translating arms, and
wherein the pair of translating arms is configured, while being positioned at the approximate level of the material storage location, to move from the first position within the overhead material transport vehicle to the second position outside of the vehicle by moving laterally toward the first side of the overhead track, thereby positioning the pair of arms adjacent to and on opposing sides of the shelf.

4. The system of claim 3 wherein a width of the material unit is greater than a width of the shelf, thereby allowing portions of a bottom surface of the material unit to overhang the opposing sides of the shelf while the material unit is stored on the shelf, and
wherein the at least one conveying mechanism is configured to contact the overhanging portions of the bottom surface of the material unit while being positioned adjacent to and on the opposing sides of the shelf.

5. The system of claim 4 wherein the at least one conveying mechanism comprises a first plurality of rollers configured to contact the overhanging portions of the bottom surface of the material unit, and
wherein the first plurality of rollers is operative to move the material unit from the shelf onto at least a portion of the length of the pair of translating arms, or to move the material unit from the pair of arms onto the shelf.

6. The system of claim 5 wherein the shelf includes a second plurality of rollers on a surface thereof to facilitate the movement of the material unit to and from the shelf.

7. The system of claim 5 wherein the pair of translating arms is configured, at least while being positioned at the approximate level of the material storage location, to move from the second position outside of the overhead material transport vehicle to the first position within the vehicle, thereby moving the at least one material unit disposed thereon into the vehicle.

8. The system of claim 1 wherein the at least one material storage location includes a first material storage location disposed at the predetermined level on the first side of the overhead track, and a second material storage location disposed at the predetermined level on a second side of the overhead track, the second side of the overhead track being opposite the first side of the overhead track.

9. The system of claim 8 wherein the at least one translating arm is further configured to move from the first position proximate to the overhead hoist transport vehicle to a third position proximate to the second material storage location by moving laterally toward the second side of the overhead track, thereby allowing the at least one conveying mechanism to move at least one material unit from the second material storage location onto at least a portion of the length of the arm, or to move at least one material unit from the arm onto the second material storage location.

10. The system of claim 1 wherein the at least one material storage location comprises a plurality of material storage locations disposed in a row beside and substantially parallel to the overhead track.

11. The system of claim 1 wherein the at least one material storage location comprises a plurality of material storage locations disposed in multiple rows beside and substantially parallel to the overhead track.

12. The system of claim 11 wherein the plurality of material storage locations is arranged in an array including a plurality of rows and a plurality of columns.

13. The system of claim 1 wherein the at least one material storage location comprises a first plurality of material storage locations disposed in a row at the first side of the overhead track, and a second plurality of material storage locations disposed in a row at a second side of the overhead track, the second side of the overhead track being opposite the first side of the overhead track.

14. The system of claim 13 wherein the first plurality of material storage locations is suspended at the first side of the overhead track and the second plurality of material storage locations is suspended at the second side of the overhead track.

15. The system of claim 14 wherein the first and second pluralities of material storage locations are suspended from a ceiling.

16. The system of claim 1 wherein the at least one material storage location comprises a first plurality of material storage locations disposed in multiple rows at the first side of the overhead track, and a second plurality of material storage locations disposed in multiple rows at a second side of the overhead track, the second side of the overhead track being opposite the first side of the overhead track.

17. The system of claim 16 wherein the first and second pluralities of material storage locations are arranged in respective arrays, each including a plurality of rows and a plurality of columns.

18. The system of claim 16 wherein the first plurality of material storage locations is suspended at the first side of the overhead track and the second plurality of material storage locations is suspended at the second side of the overhead track.

19. The system of claim 18 wherein the first and second pluralities of material storage locations are suspended from a ceiling.

20. The system of claim 1 wherein the at least one material storage location is suspended at the first side of the overhead track.

21. The system of claim 20 wherein the at least one material storage location is suspended from a ceiling.

22. The system of claim 1 wherein the material unit comprises one of a Front Opening Unified Pod (FOUP) and a manufactured part.

23. A method of operating an automated material handling system, comprising the steps of:
providing at least one overhead hoist transport subsystem including an overhead track, at least one translating arm for supporting at least one material unit, and an overhead hoist transport vehicle for carrying the at least one translating arm to a plurality of track locations along the overhead track, and for lowering and raising the at least one translating arm to a plurality of levels, each level corresponding to at least one of the track locations, the at least one translating arm including at least one mechanism for conveying at least one material unit along a length of the arm;
providing at least one material storage location for storing the at least one material unit, the at least one material storage location being disposed at a predetermined level on a first side of the track;
carrying, by the overhead hoist transport vehicle, the at least one translating arm along the overhead track to a track location adjacent the material storage location;
performing, by the overhead hoist transport vehicle, at least one of lowering and raising the at least one translating arm for positioning the translating arm at approximately the predetermined level of the material storage location;
in a first moving step, at least while the at least one translating arm is positioned at the approximate level of the material storage location, moving the at least one translating arm laterally toward the first side of the overhead track from a first position within the overhead hoist transport vehicle to a second position outside of the vehicle; and
in a second moving step, moving, by the at least one conveying mechanism, at least one material unit from the material storage location onto at least a portion of the length of the arm, or from the arm to the material storage location.

24. The method of claim 23 further including the step of, at least while the at least one translating arm is positioned at the approximate level of the material storage location, moving the at least one translating arm from the second position outside of the overhead material transport vehicle to the first position within the vehicle, thereby moving the at least one material unit disposed thereon into the vehicle.

25. The method of claim 23 wherein the at least one material storage location comprises at least one shelf,
wherein the at least one translating arm comprises a pair of translating arms, and
wherein the first moving step includes, while the pair of translating arms is positioned at the approximate level of the material storage location, moving the pair of translating arms from the first position within the overhead material transport vehicle to the second position outside of the vehicle by moving laterally toward the first side of the overhead track, thereby positioning the pair of arms adjacent to and on opposing sides of the shelf.

26. The method of claim 25 wherein a width of the material unit is greater than a width of the shelf, thereby allowing portions of a bottom surface of the material unit to overhang the opposing sides of the shelf while the material unit is stored on the shelf, and
wherein the first moving step includes, while the translating arms are positioned adjacent to and on the opposing sides of the shelf, contacting, by the pair of translating arms, the overhanging portions of the bottom surface of the material unit.

27. The method of claim 26 wherein the at least one conveying mechanism comprises a plurality of rollers, and
wherein the second moving step includes contacting, by the plurality of rollers, the overhanging portions of the bottom surface of the material unit for subsequent movement of the material unit from the shelf onto at least a portion of the length of the pair of translating arms, or from the pair of arms onto the shelf.

28. The method of claim 27 further including the step of, at least while the pair of translating arms is positioned at the approximate level of the material storage location, moving the pair of translating arms from the second position outside of the overhead material transport vehicle to the first position within the vehicle, thereby moving the at least one material unit disposed thereon into the vehicle.

29. The method of claim 23 wherein the at least one material storage location includes a first material storage location disposed at the predetermined level on the first side of the overhead track, and a second material storage location disposed at the predetermined level on a second side of the overhead track,
wherein the second side of the overhead track is opposite the first side of the overhead track, and
further including the steps of:
moving the at least one translating arm laterally toward the second side of the overhead track from the first position proximate to the overhead hoist transport vehicle to a third position proximate to the second material storage location; and
moving, by the at least one conveying mechanism, at least one material unit from the second material storage location onto at least a portion of the length of the arm, or from the arm onto the second material storage location.
